(19) United States
(12) Patent Application Publication
(10) Pub. No.: US 2026/0095761 A1
(43) Pub. Date: Apr. 2, 2026

(54) CLIENT DEVICE AUTHENTICATION USING CONTACTLESS LEGACY MAGNETIC STRIPE DATA

(71) Applicant: Capital One Services, LLC, McLean, VA (US)

(72) Inventors: Evan LERNER, Midlothian, VA (US); Lara MOSSLER, McLean, VA (US)

(21) Appl. No.: 19/411,454

(22) Filed: Dec. 8, 2025

Related U.S. Application Data
(63) Continuation of application No. 18/124,930, filed on Mar. 22, 2023, now Pat. No. 12,532,170.
Application No. 18/124,930 is a continuation of application No. 16/867,736, filed on May 6, 2020, now Pat. No. 11,638,148.
Application No. 16/867,736 is a continuation of application No. 16/590,536, filed on Oct. 2, 2019, now Pat. No. 10,701,560.

(51) Int. Cl. H04W 12/06; G06F 3/0488; G06Q 20/32; G06Q 20/40; G06V 40/12; G06V 40/16; G07F 7/08; H04B 1/3816; H04L 9/08; H04L 9/14; H04L 9/32; H04L 9/40; H04M 1/02; H04W 12/03; H04W 12/041

(52) U.S. Cl. CPC H04W 12/06; G06Q 20/32; G06Q 20/40; G06V 40/1365; G06V 40/172; H04B 1/3816; H04L 9/0866; H04L 9/0877; H04L 9/14; H04L 9/3234; H04L 63/0853; H04M 1/0202; H04W 12/03; H04W 12/041; G06F 3/0488; G07F 7/08; H04L 2209/80

(57) ABSTRACT

A technique for generating a diversified encryption key for a contactless legacy magnetic stripe card is disclosed. The diversified key can be generated using a master key, a key diversification value and an encryption algorithm. In one example embodiment, the key diversification value can be provided by the user as a fingerprint, numeric code or photo. The user can provide the key diversification value to the card or a cellphone. The card can generate the diversified key using the user provided key diversification value. The card or the cellphone can transmit the user provided diversification value to the server and the server can regenerate the diversified key using the user provided diversification value.

### CROSS-REFERENCE TO RELATED APPLICATIONS

The subject application is a continuation of U.S. patent application Ser. No. 18/124,930, filed Mar. 22, 2023, which is a continuation of U.S. patent application Ser. No. 16/867,736, filed May 6, 2020, now U.S. Pat. No. 11,638,148, which is a continuation of U.S. patent application Ser. No. 16/590,536, filed Oct. 2, 2019, now U.S. Pat. No. 10,701,560, the complete disclosures of which are incorporated herein by reference.

### BACKGROUND

Data security and transaction integrity are of critical importance to businesses and consumers. This need continues to grow as electronic transactions constitute an increasingly large share of commercial activity. Contactless cards can be an invaluable resource in providing data security and transaction integrity. While the growing use of chip-based financial cards (e.g., EMV cards) provides certain secure features over the legacy magnetic stripe cards (MSD), the majority of contactless-accepting merchants still utilize MSD cards and MSD technology. Therefore, many card issuers still choose to support both MSD cards and EMV cards.

### SUMMARY

Because many card issuers still choose to support MSD cards in this country, technologies that facilitate transaction security and user authentication for these cards are desirable. In particular, it is important to enhance card security for contactless legacy magnetic stripe cards when it comes to interactions with cellphones or similar client devices. Example interactions can include activation, authentication or step-up authentication using mobile devices, cellphones and tablets.

In an example embodiment, a secure data transmission system including an MSD compliant card (“card”), a cellphone and a server are disclosed. The cellphone can receive protected data from the card and transmit the protected data to the server for further analysis or action. The card can have a processor and memory, and the memory of the card can store a master key (or derived key), transmission data and a counter value (and/or a key diversification value). The server can have a processor and memory, and the memory of the server can store the master key. The card and the server can be in data communication using the cellphone. The card can be configured to generate a diversified key using the master key, the counter value (and/or the key diversification value) and one or more cryptographic algorithms and store the diversified key in the memory of the card. The card can also encrypt the transmission data using one or more cryptographic algorithms and the diversified key to yield encrypted transmission data, and transmit the encrypted transmission data to the server using the cellphone. The server is configured to generate the diversified key based on the master key and the counter value (and/or the key diversification value), and store the diversified key in the memory of the server. The server can independently maintain the counter value (and/or the key diversification value) or it can receive it from the card along with or separate from the encrypted transmission data. The server can decrypt the encrypted transmission using the replicated diversified key and take further action, e.g., authorize an authentication step.

In one example embodiment, the key diversification value can be provided by the user as a fingerprint, numeric code or photo. The user can provide the key diversification value to the card or the cellphone. In this embodiment, the card can create the diversified key using the user provided key diversification value. The card or the cellphone can transmit the user provided diversification value to the server and the server can recreate the diversified key using the user provided diversification value.

In an example embodiment, the card can include a derived key and a cryptographic algorithm. The card can generate a cryptogram using the derived key and the cryptographic algorithm (e.g., dCVV in Visa or CVC3 in MasterCard). The card can transmit the cryptogram to the cellphone and the cellphone can transmit the cryptogram to the server. The server can validate the cryptogram and authorize a transaction if the cryptogram is validated. In this example embodiment, the derived key is specific to each card. For example, at BIN level, there can be a primary key (or Master Key). The derive key can be generated using an algorithm leveraging the primary key, a PAN, and a PAN Sequence Number.

### BRIEF DESCRIPTION OF THE DRAWINGS

FIG. 1A illustrates a contactless card according to an example embodiment.

FIG. 1B illustrates an exemplary contact pad including an NFC tag behind the contact pad.

FIG. 2 illustrates a cellphone according to an example embodiment.

FIG. 3 illustrates a data transmission system according to an example embodiment.

FIG. 4 illustrates a flow chart for encryption and transmission of sensitive data from the card to the server through the cellphone.

FIG. 5 illustrates exemplary hardware components for a server.

### DETAILED DESCRIPTION

An objective of some embodiments of the present disclosure is to build one or more keys into a contactless legacy magnetic stripe card. The contactless card can perform authentication and numerous other functions that can otherwise require the user to carry a separate physical token in addition to the contactless card. By employing a contactless interface, contactless cards can interact with a client device (such as a mobile phone). The client device can relay any encrypted data provided by the card to a backend server, which can in turn authorize various transactions, e.g., authentication of the user.

In one example embodiment, an MSD card or a contactless legacy magnetic stripe card (hereinafter “card”) can be compliant with one or more of the following standard: ISO/IEC 7810, ISO/IEC 7811, ISO/IEC 7812, ISO/IEC 7813, ISO 8583, and ISO/IEC 4909. These standards can define the physical properties of the card, including size, flexibility, location of the magnetic stripe, magnetic characteristics, and data formats.

The size of a card can be the same as the size of a payment card, credit card or a debit card. According to ID-1 of the ISO/IEC 7810 standard, the dimensions of a card can be 85.60 by 53.98 millimeters (3.37 in×2.13 in). However, a card according to these disclosures can have a different size, and it is not necessary for a card to be implemented in a payment card.

In an example embodiment, the card can include a magnetic stripe which can store data by modifying the magnetism of the iron-based magnetic particles on a band of magnetic material on the card. The magnetic stripe can be read by swiping past a magnetic reading head. In an example embodiment, there can be up to three tracks on magnetic cards known as tracks 1, 2, and 3. Point-of-sale card readers almost always read track 1, or track 2, and sometimes both, in case one track is unreadable. The minimum cardholder account information needed to complete a transaction can be present on both tracks.

In one example embodiment, track 1 can include information such as primary account number (“PAN”), name, expiration date, service code and discretionary data (e.g., Pin Verification Key Indicator (PVKI), PIN Verification Value (PVV), Card Verification Value or

Card Verification Code (CVV or CVC)). In one example embodiment, track 2 can include PAN, expiration date, service code and discretionary data (e.g., same as track 1).

A card can include processing circuitry for storing and processing information. The processing circuitry can include processors, memories, error and parity/CRC checkers, data encoders, anticollision algorithms, controllers, command decoders, security primitives and tamperproofing hardware.

The storage of information can take place in a memory of the processing circuitry, which can be a read-only memory, write-once read-multiple memory or read/write memory, e.g., RAM, ROM and EEPROM. A card can include one or more of these memories which can store information including the information stored on any one of the tracks of card. The contactless card can transfer the information stored on these memories of the contactless card using the NFC technology. A read-only memory can be factory programmable as read-only or one-time programmable. One-time programmability provides the opportunity to write once then read many times. A write once/read-multiple memory can be programmed at a point in time after the memory chip has left the factory. Once the memory is programmed, it cannot be rewritten, but it can be read many times. A read/write memory can be programmed and re-programed many times after leaving the factory. It can also be read many times.

The memory of a card can be divided into several zones, each provided with a different level of security. The card processor can keep track of which memory addresses belong to which zones and the circumstances under which each zone can be accessed. A card processor can also process information and store the information onto the memory. In an example embodiment, a card memory can be divided into four zones: a secret zone, a confidential zone, a usage zone, and a public zone.

A secret zone can be used for storage of information which can be used only by the processor itself, e.g., passwords, cryptographic keys. The information stored in this zone is not readable outside of the card. In an embodiment, the secret zone can be implemented with a separate processor that is capable of performing cryptographic functions. Cryptographic keys can be passed into the secret zone or can be generated in the secret zone, and in either case the keys can be stored in the secret zone and used to support cryptographic services. If necessary, cryptographic keys can be exported from the secret zone.

In an example embodiment, the card can be a JavaCard which can include one or more applets. The applets can be firewalled, and data can be allocated to the applet for storage. The data can be stored transactionally in an EEPROM flash memory, e.g., if the write isn't complete when the power is removed, the contents remain the same as before.

A confidential zone can be used to store a list of all transactions made with the card. The confidential zone can have password protection. In an example embodiment, the password is known only to the card issuer, who can examine the history of the card for evidence of misuse of the system. The confidential zone can have a read-only access restriction so that the information stored in this zone could not be modified, e.g., transaction list could not be modified. A usage zone could be used for storage of information which can be periodically updated or modified. Depending on the sensitivity of the data, a password can be implemented for this zone. The usage zone can have both read and write access protected by a password. A public zone can be used for keeping nonsensitive information, such as the card issuer's name and address. The public zone can have read-only access, without a password.

In an example embodiment, the card can store one or more key diversification values. The card can use these key diversification values to create a diversified key. For example, the card can store a counter value. The counter value can be derived from a counter module, and the counter module can increment the counter value each time the card interacts with the cellphone or server. As another example, the card can store a plurality of fingerprints and store a diversification value in association with each fingerprint. The card can include a fingerprint reader, and when the user scans a finger at the fingerprint reader, the card can determine if any of the stored fingerprints is scanned at the fingerprint reader. The card can also choose the diversification value that is associated with the scanned fingerprint. The chosen diversification value can be used to generate the diversified key. As yet another example, the card can store a set of random diversification values. As yet another example, the card can receive a diversification value from an input device installed on the card (e.g., keypad or fingerprint reader) or through a contactless transmission from the cellphone.

Some cards can require physical contact with a client device (or reader/writer, reader, or scanner) to provide the information stored on the card to the client device or to write information on the card. Other cards can be contactless, i.e., the cards can wirelessly communicate with the client device. A contactless card can be a credit card including a magnetic tape or a radio-frequency identification (“RFID”) tag. Some contactless cards can include both the magnetic tape and the RFID tag. Some cards can be compatible with wireless communication technologies such as NFC, Bluetooth, Wi-Fi, etc.

A terminal can communicate with a contact card by establishing electrical contact between the card and the terminal. As such, a contact card can have a contact area comprising several contact pads. The area can be approximately 1 square centimeter (0.16 sq in). Establishing contact between the pads and the terminal can be achieved by inserting (or dipping) the contact card into the terminal. Using the electrical connection, the terminal can transmit signals to the card, and in response, the card can transmit its information to the terminal. Generally, contact cards do not contain a battery. However, in some embodiments, contact cards can include batteries.

A client device can communicate with a contactless card if the contactless card is held in proximity to the client device. The client device can read the contactless card over a short distance using near-field communication (“NFC”) technology, which uses radio frequency induction. A contactless card can include an inductor to capture some of the incident radio-frequency interrogation signal transmitted by the terminal, rectify it, and use it to power the card's processing circuitry. As such, contactless cards can function without an internal power source. However, in some embodiments, contactless cards can include an internal power source.

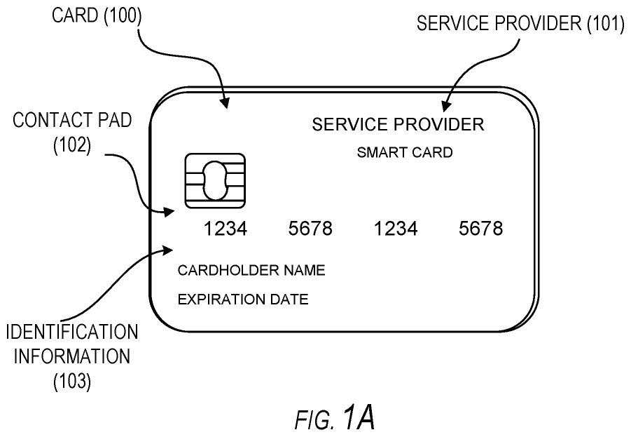

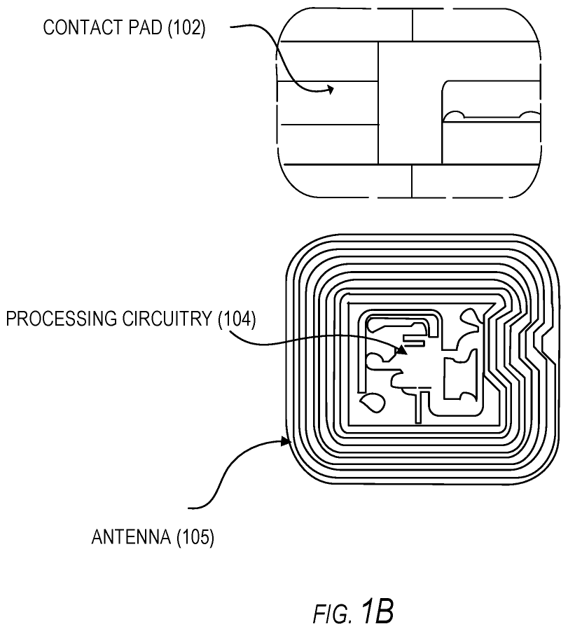

FIG. 1A illustrates a contactless card 100 according to an example embodiment. In this embodiment, the card 100 can be a payment card issued by a service provider 101 which can be displayed on the front or back of the card 100. The size of the card 100 can be compliant with ID-1 of the ISO/IEC 7810 standard, i.e., 85.60 by 53.98 millimeters. The card 100 can include a contact pad 102 for establishing contact with a contact terminal. The card 100 can also include processing circuitry, antenna and other components not displayed in FIG. 1A. These components can be located behind the contact pad 102. The card 100 can also include various identification information 103 displayed on front or back of the card. The card 100 can also include a magnetic stripe or tape, which can be located on the back of the card.

In an example embodiment, the card is provided with a near field communication (“NFC”) tag. In some embodiments, the NFC tag can include processing circuitry for storing and processing information that modulates and demodulates a radio-frequency signal (usually received from a client device, reader/writer or scanner). The NFC tag can also include an anti-collision algorithm, authentication and cryptographic mechanism, RF interface circuit, and RF antenna operating at 13.56 MHz. The RF antenna can receive and transmit a signal. Additionally, an RFID tag can include a power source or means for collecting DC power from the incident terminal signal. These means can include modulators, voltage regulators, resets, and connections to an antenna. The antenna can be an electric dipole antenna or a coil antenna.

There can be several kinds of NFC tags, e.g., active tags, battery-assisted passive tags and passive tags. An active tag can be electrically coupled to a power source, such as a battery, which can power the integrated circuit. As a result, an active tag can periodically transmit as a signal the information stored on the tag. A battery-assisted passive tag can have an activateable power source electrically coupled to it, and the power source can be activated when the tag is exposed to a signal from a terminal. A passive tag is not powered by a power source. Rather, the tag is energized by the radio energy transmitted to the tag by the terminal.

In an example embodiment of a passive NFC tag, the tag relies on a signal from the client device to power up. The tag can include modulators, voltage regulators, resets, and connections to an antenna. The antenna can be an electric dipole antenna or a coil antenna, and the processing circuitry of the tag can be connected to the antenna. The type of the antenna can be determined based on the frequency band used by the tag. Typically, an electric dipole antenna is used with an ultra-high frequency tag, but high frequency tags use a coil antenna. For example, the antennas for an NFC tag can be a simple dipole if the tag uses 915-MHz frequency, but the antenna can be a complex coiled shape if the tag uses 13.56-MHz frequency. The antenna captures and transmits signals to and from the terminal. The coupling from the terminal to the tag provides both the transmission data and the power to operate the passive NFC tag.

FIG. 1B illustrates an exemplary contact pad 102 including an NFC tag behind the contact pad 102. In this example embodiment, the contact pad 102 can include several gold-plated pads. Behind the contact pad 102, there can be processing circuitry 104 and an NFC tag. The NFC tag can include an antenna 105. In this example embodiment, the processing circuitry 104 is part of the NFC tag.

In some embodiments, the antenna of the NFC tag of the card can be placed within the card and around the contact pad 102. In other embodiments, the NFC tag of the card can include several antennas. For example, in addition to antenna 105, the card can include an antenna which extends around the contact pad 102 and throughout the card 100. Other combinations are also possible. In some embodiments, the antenna can be external to the contact pad and the processing circuitry. In some other embodiments, there can be an antenna integral with the processing circuitry and the antenna can be used with an external booster coil.

In an example embodiment, the coil of a card can act as the secondary of an air core transformer. The terminal can communicate with the card by cutting power or amplitude modulation. The card can infer the data transmitted from the terminal using the gaps in the card's power connection, which is functionally maintained through capacitors. The card can communicate back by switching a load on the card's coil or load modulation. Load modulation can be detected in the terminal's coil through interference.

In an example embodiment, the card can include a keypad and/or fingerprint reader. Using the keypad and/or fingerprint reader, the user can provide input to the card. For example, using the keypad, the user can provide a code to the card, which the card can use as a key diversification value. Similarly, the user can scan and store the user's fingerprint on the card.

The card can associate each fingerprint scanned and stored on the card with an encryption algorithm (or a key diversification value). By scanning the user's fingerprint, the user can specify which encryption code the card can use.

A client device can be a cellphone, a mobile phone or a tablet. A client device can read information from a card and write information onto the card. In some embodiments, the client device can pass information from the card to a host computer and write information from the host computer into the card. In some embodiments, the host computer can be the client device. The client device can provide power to the card and link the card's hardware interface to the host computer. Since the card's processor can control the actual flow of information into and out of the card's memories, the client device can operate with only minimal processing capabilities for sending the information to the host computer.

In some embodiments, the client device can include a processor and a transceiver. The transceiver can send and receive data from the card using the NFC protocol. The processor of the client device can decode any data received from the card. The client device can also update, delete or modify the information stored on the card.

A client device can write data on the card by passing the data to the processor of the card. The processor can process the data and store it in the card's memory. A client device can have a two-way communication with a card as described in ISO 14443. The card can include an NFC tag. The two-way communication can be digitally encoded. There can be several frequency ranges, and several proprietary formats for the two-way communication. The 13.56 Mhz frequency range (NFC) is dominated by ISO 14443 compatible cards.

A client device and a card can exchange messages, which can include commands or data. For example, a client device can send a command message to the card, the card can process the command message in its processor and the card can send back a response message to the client device. Each of the command message and the response message can include data. A message can include TLV (Type, Length and Value) data and a command such as STORE_DATA command which prompts storage of the data included in the message in the card.

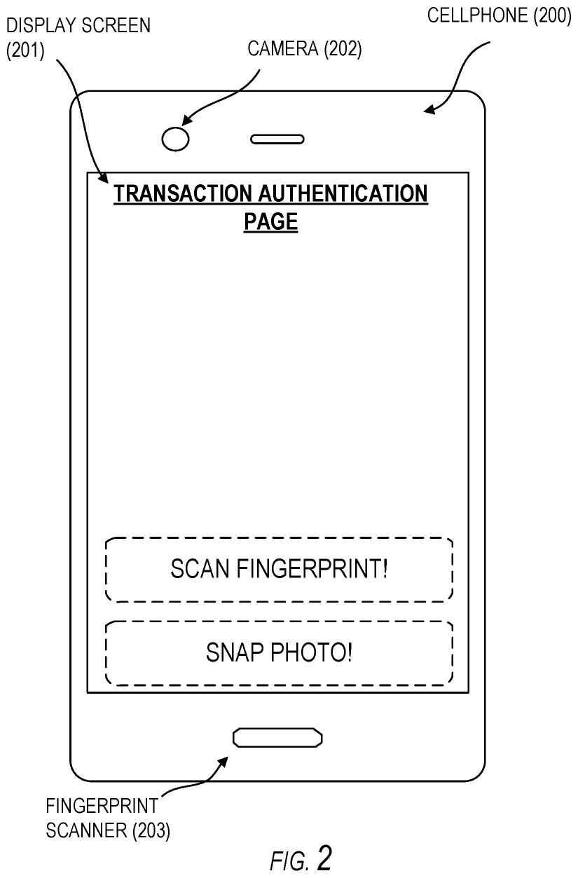

FIG. 2 illustrates a cellphone 200 according to an example embodiment. In this example embodiment, the cellphone 200 can include a display screen 201, camera 202 and fingerprint scanner 203. The display screen 201 can be any type of display screen, e.g., a touchpad LCD display screen. Using the touchscreen 201, for example, a customer can enter information into the cellphone 200. As another example, by pressing a graphical user interface button, the user can command the camera 202 to take a photo of the user. The camera can store the photo and/or transmit the photo to a backend server. As yet another example, the user can command the cellphone 200 to scan the user's fingerprint using the fingerprint scanner 203. The cellphone 200 can store the fingerprint and/or transmit the fingerprint to the card or backend server.

In an example embodiment, the cellphone can be an NFC compatible cellphone, which can include antennas for sending and receiving signals, a transceiver, and a processor to decode data. For a passive NFC tag, the cellphone can transmit an energy field that can wake up the tag (or card) and power its chip, enabling it to transmit or store data. In turn, the tag converts the radio signal into usable power, and responds to the cellphone in the form of a radio signal. The signal can include the tag's identity and other information. Once the cellphone receives the response, the cellphone converts the response and extracts any information included in the radio signal. The information collected from the tag is then transferred through a communications interface to a backend server, where the data can be stored in a database or analyzed by the server. The cellphone can also update, delete or modify the information stored on the card.

In the example embodiment of FIG. 2, the cellphone 200 is provided with one or more antennas (not displayed), which enable the device to read information from a contactless card and write information on the contactless card.

In these disclosures, the terms client device, cellphone, reader/writer, scanner and terminal have been used interchangeably, and they all refer to a device which can scan a card and/or write information on the card. In some embodiments, the cellphone can be connected to a backend server. In other embodiments, the cellphone can be integrated in the backend server.

In an example embodiment, the cellphone can include one or more of the following: a fingerprint reader, a camera, and an application for receiving input from the user (e.g., a PIN code, key diversification value, or identification number). The cellphone can transmit any input provided by the user to a backend server and the card for, e.g., key diversification purposes. For example, the backend server can store a plurality of fingerprints for the user and the server can associate an encryption algorithm with each one of the fingerprints. When scanning the card at the cellphone, the cellphone can also receive the user's fingerprint (or other information, e.g., a photo or PIN number) and transmit this information to the backend server. Using this information, the backend server can determine which encryption algorithm was used in the key diversification process.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data an attacker has which was processed with the same key, the greater the likelihood that the attacker may discover the value of the key. A key used frequently may be comprised in a variety of different attacks.

Moreover, each time a symmetric cryptographic algorithm is executed, it can reveal information, such as side-channel data, about the key used during the symmetric cryptographic operation. Side-channel data can include minute power fluctuations which occur as the cryptographic algorithm executes while using the key. Sufficient measurements can be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

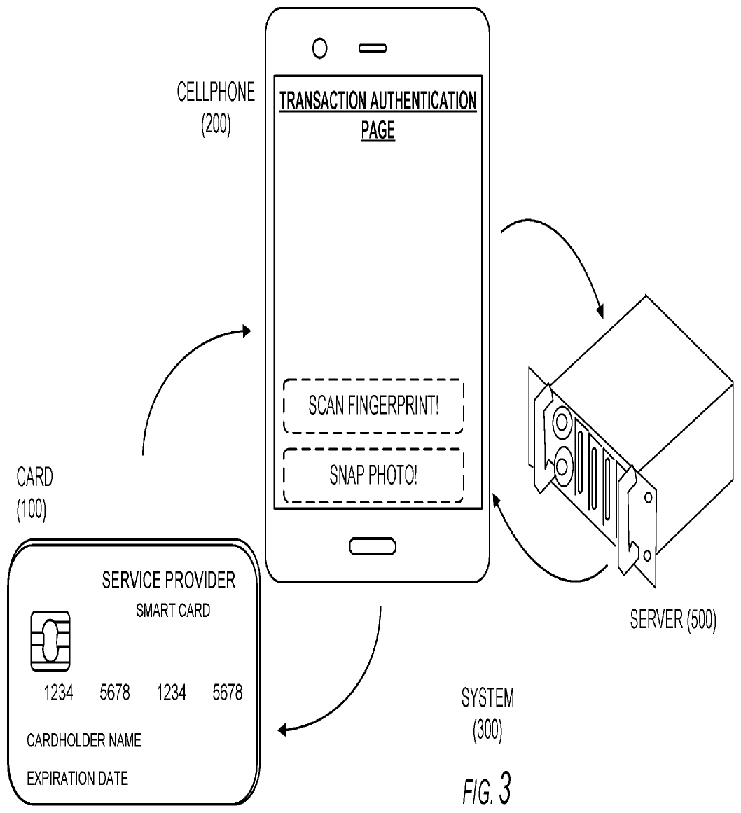

FIG. 3 illustrates a data transmission system according to an example embodiment. System 300 can include a card 100 and a cellphone 200 in communication, for example via a network, with one or more servers 500. The system 300 can be configured to implement a key diversification algorithm. For example, a sender (e.g., card) and recipient (e.g., backend server) can desire to exchange data (e.g., sensitive data) via the cellphone 200.

In some examples, the card 100 and the server 500 can be provisioned with the same master symmetric key. The symmetric key can be kept secret from all parties other than the card 100 and the server 500 involved in exchanging the secure data. It is further understood that part of the data exchanged between the card 100 and server 500 comprises at least a portion of data which may be referred to as sensitive data, counter value, or other types of data (e.g., a key diversification value). The counter value may comprise a number that changes each time data is exchanged between the card 100 and the server 500. In this disclosure, the counter value and the key diversification value can be used as referring to the same value or a different value, both of which are within the scope of this disclosure.

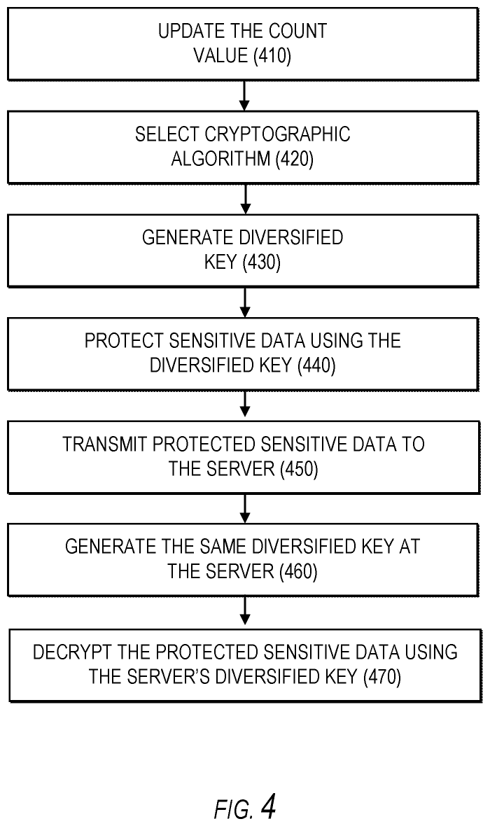

FIG. 4 illustrates a flow chart for encryption and transmission of sensitive data from the card 100 to the server 500 through the cellphone 200. At step 410, when the card 100 is preparing to process the sensitive data with symmetric cryptographic operation, the card 100 can update a counter. Both the card 100 and the server 500 can store a value representing the counter. This value can be updated each time the card 100 and the server 500 interact. At step 420, the card 100 can select an appropriate symmetric cryptographic algorithm, which can include at least one of a symmetric encryption algorithm, HMAC algorithm, and a CMAC algorithm. The algorithm selection of the card 100 can be based on an input, which can be provided by data stored on the card 100 (e.g., counter value), data received from the user (e.g., input pad of the card 100), or data provided by the cellphone 200 or server 500.

In some examples, the symmetric algorithm can comprise any symmetric cryptographic algorithm used to generate a desired length diversified symmetric key. Non-limiting examples of the symmetric algorithm can include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which can be combined as needed to produce sufficient length keys.

At step 430, the card 100 can generate a diversified key. For example, the diversified key can be generated by encrypting the counter value (i.e., key diversification value) with the selected symmetric encryption algorithm using the master symmetric key, thereby creating a diversified symmetric key. As another example, the master key and the key diversification value can be provided as an input to an encryption algorithm and the output can be the diversified (symmetric) key. The diversified symmetric key can be used to process the sensitive data before transmitting the result to the server 500 through the cellphone 200.

At step 440, the sensitive data can be protected using one or more cryptographic algorithms and one or more diversified keys. The diversified key, which was created in step 430, can be used with one or more cryptographic algorithms to protect the sensitive data. In some examples, a plurality of cryptographic operations may be performed using the diversified symmetric keys prior to transmittal of the protected data. For example, the data can be processed by a MAC using a first diversified session key, and the resulting output can be encrypted using a second diversified session key producing the protected data. The cryptographic algorithms can be selected using an algorithm selection technique.

In one example embodiment, the sensitive data can include data similar to data stored in track 1 or track 2 of a magnetic stripe card. In another example embodiment, the sensitive data can include the counter value. In yet another example embodiment, the sensitive data can include other data provided by the card 100 or cellphone 200, e.g., a number inputted by a keypad of the card 100 or a photo captured by the cellphone 200.

At step 450, the protected data (i.e., the sensitive data that was protected in step 430) can be transmitted to the cellphone 200 and the cellphone 200 can transmit the protected data to the server 500. At step 460, the server 500 can perform the same symmetric encryption using the counter value as input to the encryption and the master symmetric key as the key for the encryption. The output of the encryption can be the same diversified symmetric key value that was created by the card 100. For example, the server 500 can replicate the diversified key created at the card 100 and using the replicated diversified key, decrypt the protected data. As another example, the server 500 can independently create its own copies of the first and second diversified session keys using the counter value. Then, the server 500 can decrypt the protected data using the second diversified session key to reveal the output of the MAC created by the card. The server 500 can then process the resultant data through the MAC operation using the first diversified session key.

In one embodiment, at step 470, the server 500 can use the diversified key to decrypt the protected sensitive data. In another embodiment, at step 470, the server 500 can use the diversified keys with one or more cryptographic algorithms to validate the protected data, and at step 480, the original data may be validated. For example, if the output of the MAC operation matches the MAC output revealed by decryption, then the data may be deemed valid.

The next time sensitive data needs to be sent from the card 100 to the server 500 via the cellphone 200, a different counter value can be selected producing a different diversified symmetric key. By processing the counter value with the master symmetric key and same symmetric cryptographic algorithm, both the card 100 and the server 500 can independently produce the same diversified symmetric key. This diversified symmetric key, not the master symmetric key, is used to protect the sensitive data.

Both the card 100 and the server 500 each initially possess the shared master symmetric key. The shared master symmetric key is not used to encrypt the original sensitive data. Because the diversified symmetric key is independently created by both the card 100 and the server 500, it is never transmitted between the two parties. Thus, an attacker cannot intercept the diversified symmetric key and the attacker never sees any data which was processed with the master symmetric key. As a result, reduced side-channel data about the master symmetric key is revealed. Moreover, the operation of the card 100 and the server 500 can be governed by symmetric requirements for how often to create a new diversification value, and therefore a new diversified symmetric key. In an embodiment, a new diversification value and therefore a new diversified symmetric key can be created for every exchange between the card 100 and the server 500.

In some examples, the key diversification value can comprise the counter value. Other non-limiting examples of the key diversification value include: a random nonce generated each time a new diversified key is needed, the random nonce sent from the card 100 to the server 500; the full value of a counter value sent from the card 100 to the server 500; a portion of a counter value sent from the card 100 to the server 500; a counter independently maintained by the card 100 and the server 500 but not sent between the two devices; a one-time-passcode exchanged between the card 100 and the server 500; and a cryptographic hash of the sensitive data. In some examples, one or more portions of the key diversification value can be used by the parties to create multiple diversified keys. For example, a counter may be used as the key diversification value. Further, a combination of one or more of the exemplary key diversification values described above can be used.

In another example, a portion of the counter can be used as the key diversification value. If multiple master key values are shared between the parties, the multiple diversified key values can be obtained by the systems and processes described herein. A new diversification value, and therefore a new diversified symmetric key, can be created as often as needed. In the most secure case, a new diversification value can be created for each exchange of sensitive data between the card 100 and the server 500. In effect, this can create a one-time use key, such as a single-use session key.

In one example embodiment, the key diversification value can be the counter value. However, in other example embodiments, in addition to or instead of the counter value, the key diversification value can be determined based on an input provided by the user.

For example, the user can use the keypad on a screen of a cellphone to specify a numeric code. The cellphone can transmit this numeric code to the card and the server as the key diversification value. As another example, the user can use the keypad on the card to specify a numeric code. The card can use this numeric code as the key diversification value. The card can also transmit this diversification value to the cellphone which can in turn transmit this code to the server. The numeric code can be encrypted when it is transmitted to the cellphone. As another example, the user can provide a fingerprint on a fingerprint reader of the card or cellphone. Using the fingerprint, the card or the cellphone can determine a key diversification value. For example, if the user sets up the fingerprint on the cellphone, at the time of setup, for each finger the user scans, the user specifies an alphanumeric value. The cellphone can store each fingerprint and the alphanumeric value in an association. Subsequently, when the user desires to authorize a transaction, the user can scan the user's finger and tap the card on the cellphone. The cellphone can transmit the key diversification value associated with the fingerprint to the card and the server. Both the card and the server can use the key diversification value to create the diversified key.

As another example, the user can scan the user's finger on the card. In this example, when the user scans the user's finger, using the keypad of the card, the user can specify a key diversification value associated with each fingerprint provided by the user. Subsequently, when the user scans the user's finger at the card, the card uses the associated key diversification value in the encryption operation. The card can transmit the encrypted data and the key diversification value to the cellphone, which can in turn transmit the key diversification value to the server. In one example, at the time of setup, the user can scan the user's fingers on the card (or the cellphone). Once the setup is done, the user can scan the card at the cellphone. The card (or the cellphone) can transmit the association of fingerprints and the key diversification values to the cellphone (or the card). In this example, when the user desires to authorize a transaction, the user can scan the user's fingerprint at the card and the cellphone, and there will be no need for transmission of the diversification value between the cellphone and the card.

In one example embodiment, the card and the server can use fingerprint associations for selection of the encryption algorithm. For example, a user can define a relationship between each fingerprint and an encryption algorithm. When the user scans the user's finger at the cellphone (or the card), either the cellphone or the card can determine a defined encryption algorithm for the scanned fingerprint.

In one example embodiment, the cellphone is configured to take a photo of the user and transmit the photo of the user to the server. The server can determine a key diversification value and/or an encryption algorithm based on the photo. In one embodiment, when the server receives the user's photo, as a threshold matter, the server can perform a facial recognition function to determine whether the photo belongs to the user of the card. If the server determines that the photo belongs to the user, the server can determine a facial expression of the user in the photo. For example, if the user smiles, the server can associate the user's facial expression with a first diversification value and/or a first encryption algorithm. However, if the user closes his or her eyes, the server can associate the user's facial expression with a second diversification value and/or a second decryption algorithm. Subsequently, the server can transmit the diversification value and/or decryption algorithm associated with the facial expression to the cellphone and the cellphone can transmit the diversification value and/or decryption algorithm to the card. The card can generate a diversified key using the associated diversification value and/or select the associated decryption algorithm for encryption of the sensitive data. In another embodiment, the server can determine a color of an outfit of the user and determine the diversification value and/or encryption algorithm based on the color of the outfit.

In one example embodiment, the cellphone can transmit the user's photo to the server and the server can transmit a hash of the photo to the cellphone. The cellphone can transmit the hash of the photo to the card. The card can use the hash of the photo as the diversification value.

In one example embodiment, the diversification value can be selected based on a fingerprint input provided by the user and the encryption algorithm can be selected based on a photo submitted by the cellphone to the server. For example, using the fingerprint, the cellphone can determine a diversification value and transmit the value to both the card and the server. Additionally, using the photo, the server can determine an encryption algorithm. The server can transmit the selected encryption algorithm to the cellphone and the cellphone can transmit the selected encryption algorithm to the card.

In one example embodiment, the diversification value can be a combination of multiple diversification values. For example, the diversification value can be a cryptographic combination of a diversification value derived using a fingerprint and a diversification value derived using a photo of the user.

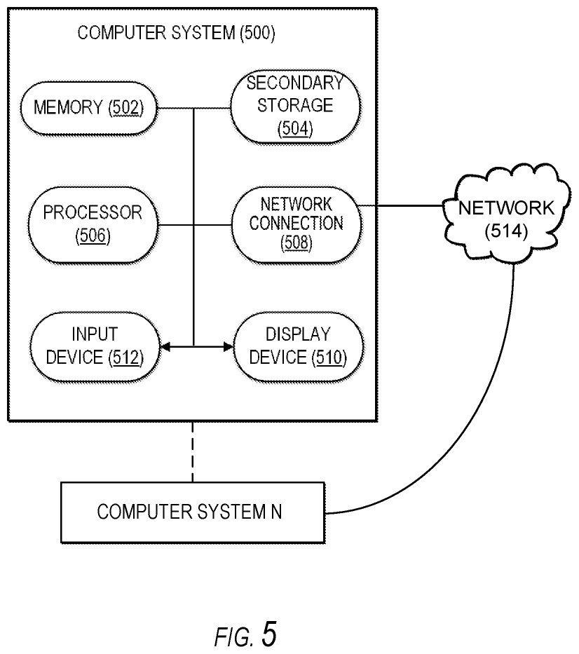

FIG. 5 illustrates exemplary hardware components of a server. A computer system 500, or other computer systems similarly configured, may include and execute one or more subsystem components to perform functions described herein, including the steps of various flow processes described above. Likewise, a mobile device, a cell phone, a smartphone, a laptop, a desktop, a notebook, a tablet, a wearable device, a server, etc., which includes some of the same components of the computer system 500, may run an application (or software) and perform the steps and functionalities described above. Computer system 500 may connect to a network 514, e.g., Internet, or other network, to receive inquiries, obtain data, and transmit information and incentives as described above.

The computer system 500 typically includes a memory 502, a secondary storage device 504, and a processor 506. The computer system 500 may also include a plurality of processors 506 and be configured as a plurality of, e.g., bladed servers, or other known server configurations. The computer system 500 may also include a network connection device 508, a display device 510, and an input device 512.

The memory 502 may include RAM or similar types of memory, and it may store one or more applications for execution by processor 506. Secondary storage device 504 may include a hard disk drive, floppy disk drive, CD-ROM drive, or other types of non-volatile data storage. Processor 506 executes the application(s), such as those described herein, which are stored in memory 502 or secondary storage 504, or received from the Internet or other network 514. The processing by processor 506 may be implemented in software, such as software modules, for execution by computers or other machines. These applications preferably include instructions executable to perform the system and subsystem component functions and methods described above and illustrated in the FIGS. herein. The applications preferably provide graphical user interfaces (GUIs) through which users may view and interact with subsystem components.

The computer system 500 may store one or more database structures in the secondary storage 504, for example, for storing and maintaining the information necessary to perform the above-described functions. Alternatively, such information may be in storage devices separate from these components.

Also, as noted, processor 506 may execute one or more software applications to provide the functions described in this specification, specifically to execute and perform the steps and functions in the process flows described above. Such processes may be implemented in software, such as software modules, for execution by computers or other machines. The GUIs may be formatted, for example, as web pages in HyperText Markup Language (HTML), Extensible Markup Language (XML) or in any other suitable form for presentation on a display device depending upon applications used by users to interact with the computer system 500.

The input device 512 may include any device for entering information into the computer system 500, such as a touch-screen, keyboard, mouse, cursor-control device, microphone, digital camera, video recorder or camcorder. The input and output device 512 may be used to enter information into GUIs during performance of the methods described above. The display device 510 may include any type of device for presenting visual information such as, for example, a computer monitor or flat-screen display (or mobile device screen). The display device 510 may display the GUIs and/or output from sub-system components (or software).

Examples of the computer system 500 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 500 is shown in detail, system 500 may use multiple computer systems or servers as necessary or desired to support the users and may also use back-up or redundant servers to prevent network downtime in the event of a failure of a particular server. In addition, although computer system 500 is depicted with various components, one skilled in the art will appreciate that the system can contain additional or different components. In addition, although aspects of an implementation consistent with the above are described as being stored in a memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling the computer system 500, to perform a particular method, such as methods described above.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

1. A data transmission system comprising:
a card having a processor and memory, the memory of the card containing a master key, transmission data and a counter value, wherein the card is an MSD compliant card;
a server having a processor and memory, the memory of the server containing the master key and the counter value;
a cellphone wherein the server is in data communication with the card through the cellphone;
wherein the cellphone is configured to:
receive an input from a user and, based on the input, derive a key diversification value;
transmit the key diversification value to the card;
receive encrypted transmission data from the card; and
transmit the encrypted transmission data and the key diversification value to the server;
wherein the card is configured to:
generate a diversified key using the master key, the counter value, the key diversification value and one or more cryptographic algorithms;
encrypt the transmission data using one or more cryptographic algorithms and the diversified key to yield the encrypted transmission data, and transmit the encrypted transmission data to the cellphone; and
wherein the server is configured to:
receive the encrypted transmission and the key diversification value from the cellphone;
generate the diversified key based on the master key, the counter value and the key diversification value; and
decrypt the encrypted transmission data using one or more cryptographic algorithms and the diversified key; and
transmit a communication to a second server to authenticate a transaction.

2. The data transmission system of claim 1, wherein the card is a contactless card in compliance with the following standards: ISO/IEC 7810, ISO/IEC 7811, ISO/IEC 7812, ISO/IEC 7813, ISO 8583, and ISO/IEC 4909.

3. The data transmission system of claim 1, wherein the transmission data includes an account number.

4. The data transmission system of claim 1, wherein the input is an alphanumeric code provided by the user through a touchscreen of the cellphone.

5. The data transmission system of claim 1, wherein the input is a fingerprint scanned at the cellphone.

6. The data transmission system of claim 5, wherein the cellphone stores a plurality of key diversification values in association with a plurality of fingerprints.

7. The data transmission system of claim 6, wherein the cellphone is configured to transmit to the card and the server the key diversification value associated with the fingerprint scanned at the cellphone.

8. The data transmission system of claim 1, wherein the input is a photo of the user.

9. The data transmission system of claim 8, wherein the cellphone is configured to transmit the photo to the server.

10. The data transmission system of claim 9, wherein the server is configured to conduct a facial recognition technique to match the photo to a photo of the user stored in the server.

11. The data transmission system of claim 10, wherein the server is configured to generate the key diversification value based on the photo.

12. The data transmission system of claim 11, wherein the server is configured to transmit the key diversification value to the cellphone.

13. A data transmission system comprising:
a card having a processor and memory, the memory of the card containing a master key, transmission data and a counter value, wherein the card is an MSD compliant card;
a server having a processor and memory, the memory of the server containing the master key and the counter value;
a cellphone wherein the server is in data communication with the card through the cellphone;
wherein the cellphone is configured to:
receive a first input from a user and, based on the first input, derive a key diversification value;
receive a second input from the user and, based on the second input, derive an algorithm selection value;
transmit the key diversification value and the algorithm selection value to the card;
receive encrypted transmission data from the card; and
transmit the encrypted transmission data, the key diversification value and the algorithm selection value to the server;
wherein the card is configured to:
generate a diversified key using the master key, the counter value, the key diversification value and a cryptographic algorithm selected using the algorithm selection value;
encrypt the transmission data using the cryptographic algorithm and the diversified key to yield the encrypted transmission data; and
transmit the encrypted transmission data to the cellphone; and
wherein the server is configured to:
receive the encrypted transmission, the key diversification value and the algorithm selection value from the cellphone;
generate the diversified key based on the master key, the counter value and the key diversification value using the cryptographic algorithm; and
decrypt the encrypted transmission data using the cryptographic algorithm and the diversified key; and
transmit a communication to a second server to authenticate a transaction.

14. The data transmission system of claim 13, wherein the card is a contactless card in compliance with the following standards: ISO/IEC 7810, ISO/IEC 7811, ISO/IEC 7812, ISO/IEC 7813, ISO 8583, and ISO/IEC 4909.

15. The data transmission system of claim 13, wherein the first input is a fingerprint scanned at the cellphone and the second input is an alphanumeric value entered on a touchscreen of the cellphone.

16. The data transmission system of claim 15, wherein the cellphone stores a plurality of key diversification values in association with a plurality of fingerprints.

17. The data transmission system of claim 16, wherein the cellphone is configured to transmit to the card and the server:
the key diversification value associated with the fingerprint scanned at the cellphone; and
the alphanumeric value as the algorithm selection value.

18. The data transmission system of claim 13, wherein the first input is a photo of the user.

19. The data transmission system of claim 18, wherein the cellphone is configured to transmit the photo to the server.

20. The data transmission system of claim 19, wherein the server is configured to generate the key diversification value based on the photo.
